(19) United States
(12) Patent Application Publication
(10) Pub. No.: US 2004/0007879 A1
(43) Pub. Date: Jan. 15, 2004

(54) End point power production

(76) Inventors: Frank Ruggieri, Merritt Island, FL (US); Shimao Ni, Darien, IL (US); Dave Lackstrom, Cape Canaveral, FL (US); Napoleon Salvail, Titusville, FL (US)

Correspondence Address: LAW OFFICES OF BRIAN S STEINBERGER, 101 BREVARD AVENUE, COCOA, FL, 32922, US

(21) Appl. No.: 10/414,672

(22) Filed: Apr. 16, 2003

Related U.S. Application Data
(60) Provisional application No. 60/372,869, filed on Apr. 16, 2002.

(51) Int. Cl. F02C 6/00; H02K 7/18; H02P 9/04

(52) U.S. Cl. 290/52

(57) ABSTRACT

Thermodynamic energy methods and systems that provides all electrical energy and heat needs of a single residential house, commercial business or office building. The system is small enough to be stored inside the house or building. The system can generate excess electrical energy which can be sold over the power grid and allow for the house owner, building owner or energy provider (utility company) to provide income or additional electrical generating capacity and the ability to sell/provide co-generated heat. The method and system can have combined energy conversion efficiency up to approximately 97%. Components can include amorphous materials, and the mono-tube steam generator boiler, which is explosion proof when punctured, and only emits a puff of steam when punctured. The tubes can be built to pressure vessel code. The invention can use steam generators to power A/C units, domestic hot water, hot water air space heaters, other loads such as pools and spas and underground piping to eliminate ice and snow. Additionally, the invention can be used to power vehicles such as cars, and the like.

This invention relates to energy generation and power supply systems, and in particular to methods and systems that can meet all energy demands of a home or business or industrial user, and allows for excess electrical energy to be available to be sold over a transmission grid to other users, and in particular to an expansive fluid systems and methods such as steam generation for generating electrical energy, and to use co-generated heat byproduct for domestic hot water, room heating and swimming pool/spa heating, and for powering air conditioners, and for powering vehicles, and the like, and this invention claims the benefit of priority to U.S. Provisional Application No. 60/372,869 filed Apr. 16, 2002.

### BACKGROUND AND PRIOR ART

Many problems currently exist for traditional power generation methods and systems. Approximately 95% of the current world's supply of electrical energy is produced from non-renewable sources. Alternative fuels are not practical sources for taking care of all the world's electrical energy needs. For example, solar energy power is too low, not reliable and the equipment is very expensive. Wind energy is inconsistent, not dependable, expensive, and high maintenance. Geothermal energy is only available at specific locations. Hydrogen energy has no existing infrastructure to support distribution and requires a great deal of energy to produce.

Global energy demand is increasing at approximately 2% per year. The Department of Energy has forecast by year 2020 that United States will need approximately 403 gigawatts (403 billion watts) and the world will need approximately 3,500 gigawatts (3.5 trillion watts of power). Today, there are more than two billion people in the world who do not have access to electricity.

Demand for electricity is outrunning capacity, and the price mechanism is the essential way to restrain demand and encourage supply. Therefore, the cost of electricity will keep going up.

Current electric utility companies are limited by production capacity to increase their electricity generation. To increase generation, these companies must build additional plants which require substantial capital investments, political issues of where to locate to the plants, lengthy permit procedures lasting several years, cost overruns, which make the traditional method of building additional plants undesirable.

Using nuclear power, oil burning plants, and coal burning plants, adds further environmental problems for those seeking to build electricity generating power plants. Thus, building more and more plants is not a practical solution.

Current energy conversion efficiency of any of these power plants is generally no higher than 30% (thirty percent) efficiency of the electricity produced from the energy source of the fuel (oil, coal, nuclear, natural gas). For example, turbines that generate the electricity from the fuel source at the power plants only generate up to approximately 30% efficiency of the electricity generated from the energy source. Seventy percent (70%) of the available energy is lost as heat.

Next, the electricity being transmitted loses energy (efficiency) while it is being transmitted. Energy (efficiency) is lost over transmission lines (i.e. wires, substations, transformers) so that by the time the electricity reaches the end user, an additional 28% (twenty eight percent) energy (efficiency) is lost. By the time the electricity reaches an end user such as a home residence, the true energy efficiency is no more than approximately 18% (eighteen percent) from the actual energy source.

Co-generation heat is the amount of heat that is wasted in the development of the electric power at the plant because heat cannot be transmitted over long distances.

A co-generation combined system does exist where some of the co-generated heat produced from a gas fired plant is used to produce additional steam which then makes additional electricity in addition to the primary electrical generation system. This combined system can achieve up to approximately 45% (forty five percent) energy conversion efficiency. But there still are transmission losses of some 28% (twenty eight percent) so that by the time electricity reaches the end user only some 22% (twenty two percent) of the actual energy source is available as electrical power.

The current electricity rate structure for consumers penalizes the consumers who must pay for the fuel being used to generate either 18 percent or 22 percent energy available to the end user. In essence, the consumer is paying for some 500% (five hundred percent) of the actual cost of electricity by inherent transmission losses that result in the current power generation and transmission systems.

The inventors are aware of several patents used for steam power generation. See for example, U.S. Pat. No. 3,567,952 to Doland; U.S. Pat. No. 3,724,212 to Bell; U.S. Pat. No. 3,830,063 to Morgan; U.S. Pat. No. 3,974,644 to Martz et al.; U.S. Pat. No. 4,031,404 to Martz et al.; U.S. Pat. No. 4,479,354 to Cosby; U.S. Pat. No. 4,920,276 to Tateishi et al.; U.S. Pat. No. 5,497,624 to Amir et al.; U.S. Pat. No. 5,950,418 to Lott et al.; and U.S. Pat. No. 6,422,017 to Basily. However, none of these patents solves all the problems of the wasteful energy conversion methods and systems currently being used.

### SUMMARY OF THE INVENTION

A primary objective of the invention is to provide a more efficient method and system to generate electrical power and heat to supply individual homeowners and businesses to make them independent of the traditional electrical company at a much lower cost/efficiency.

A secondary objective of the invention is to provide a method and system to generate electrical power that provides for all the energy needs to supply electricity, hot water, heating and cooling for individual homeowners and businesses.

A third objective of the invention is to provide a method and system to generate electrical power and heat energy for the needs of individual homeowners and businesses, that allows for their excess energy to be sold to others further reducing costs to homeowners and businesses. Current estimates would allow for selling approximately $10,000 to approximately $22,000 per year worth of excess energy to others through an existing electrical power grid.

A fourth objective of the invention is to provide a method and system to generate electrical power to supply all the energy needs of individual homeowners and businesses that is inexpensive. An estimated cost of the novel invention system would be under $10,000 for the entire system.

A fifth objective of the invention is to provide a method and system to generate electrical power and heat that can reduce national residential energy consumption substantially over current levels.

A sixth objective of the invention is to provide a method and system to generate electrical power and heat that reduces United States' dependency on foreign sources of energy such as oil imports.

A seventh objective of the invention is to provide a method and system to generate electrical power and heat that can use any energy source such as renewable (alcohol, hydrogen, etc) and non renewable (oil, coal, gas, etc.) in an efficient energy conversion method and system.

An eighth objective of the invention is to provide a method and system to generate electrical power and heat that achieves an energy conversion efficiency of approximately 95% (ninety five percent) or greater.

A ninth objective of the invention is to provide a method and system to generate electrical power and heat that does not charge the end user for fuel source energy that is being lost and not being used to generate the actual electricity available to the end user.

A tenth objective of the invention is to provide a method and system to generate electrical power and heat that can use existing power generation infrastructures such as existing natural gas pipelines, propane gas tanks, and the like.

An eleventh objective of the invention is to provide a method and system to generate electrical power and heat that does not require building new plants, substantial capital expenditures, permitting costs, political headaches of where to locate plants, and the like.

A twelfth objective of the invention is to provide a method and system to use superheated steam generated by a vaporous fuel source to supply hot water for uses such as but not limited to domestic hot water, home/space heating, and other loads such as pools, spas, and underground piping for ice and snow removal.

A thirteenth objective of the invention is to provide a method and system to use superheated steam generated by a vaporous fuel source to power an airconditioning unit.

A fourteenth objective of the invention is to provide a method and system to use superheated steam generated by a vaporous fuel source to generate electricity for powering commercial and domestic devices.

A fifteenth objective of the invention is to provide a method and system to use superheated steam generated by a vaporous fuel source to power a vehicle such as a car.

The invention can use any potential source of energy, such as renewable and nonrenewable energy. A preferred embodiment can use natural gas, liquid propane gas, and the like. Additionally, the invention can run on coal, oil or any fuel that can be vaporized. Ultimately the device will be made to run on water; thru the use of advanced techniques (blue laser, electrolysis) of breaking the bi-polar bond of H₂O and use the gasses H₂ and O₂.

A preferred embodiment can have simple and user-friendly automated controls controlled by software, that can monitor and control the entire system. The size of the system can be no larger than approximately 3 feet by 4 feet by 5 feet, and weigh no more than approximately 500 pounds, and have an almost silent operation. The novel method and system can meet the minimum energy needs of a residential home or business.

At a maximum output of 15 KW, the embodiments can additionally supply excess electrical energy to sell over a transmission grid, which can generate extra income for the user that can be in the range of approximately $10,000 to approximately $22,000 per year, which can easily pay back the costs to buy the system. The embodiments are scalable and can be built to produce 20 KW, 30 KW, or more.

Other embodiments of the invention use superheated steam generated from a vaporous fuel source to power electric and shaft driven air conditioning units, vehicles such as cars, and the like.

Further objectives and advantages of this invention will be apparent from the following detailed description of the presently preferred embodiments which are illustrated schematically in the accompanying drawings.

### BRIEF DESCRIPTION OF THE FIGURES

FIG. 1 is an overview diagram of a first preferred embodiment of the invention.

FIG. 2A is a cross-sectional view of a dual wrap fin coil heat generator (boiler) 3 for the embodiment of FIG. 1, and can be used for compact spaces when space restricts height dimensions of a boiler.

FIG. 2B shows a cross-sectional view of a single wrap fin coil heat generator (boiler) 3 for the embodiment of FIG. 1 that can be used where height restrictions are not a problem.

FIG. 3 shows the heat recovery unit 4 for the embodiment of FIG. 1.

FIG. 4 shows air preheater component 1 for the embodiment of FIG. 1.

FIG. 5A is a perspective view of an expander drive 8 for the embodiment of FIG. 1.

FIG. 5B is an inner view of the expander drive 8 of FIG. 5A.

FIG. 6 is a cross-sectional view of the expander drive 8 of FIG. 5A along arrows 6X.

FIG. 7 shows the steam to water exchanger (Co Generation Steam condenser) 10 for the embodiment of FIG. 1.

FIG. 8A shows the steam dissipation coil (heat dissipation/steam condenser) 11 for the embodiment of FIG. 1.

FIG. 8B is an end view of the coil and fan assembly of 11 FIG. 8A.

FIG. 9A shows the condensate return pump (high pressure return pump) 5 for the embodiment of FIG. 1.

FIG. 10B is a cross-section of the novel rifled and turbulator tubing used in the A/C unit 19 of FIG. 1.

FIG. 11 shows a wiring diagram for various components for FIG. 1.

FIG. 12 shows a preferred layout of all the components of the invention in a 3′ by 4′ by 5′ box for use by the end user of the invention.

FIG. 13 shows a second preferred embodiment for heat generation using a closed loop steam generator system.

FIG. 14 shows a third preferred embodiment for powering a drive shaft driven airconditioner unit using the novel steam generator, expander drive and steam condenser of the invention, which is a vaporous fuel supplied air conditioner

FIG. 15 shows a fourth preferred embodiment for supplying electricity to any electrically powered device or system using the novel steam generator, expander drive and steam condenser of the invention.

FIG. 16 shows a fifth preferred embodiment for supplying electrical power to an electric vehicle, such as an electric car using the novel steam generator, expander drive and steam condenser of the invention.

FIG. 17 shows a sixth preferred embodiment for powering a drive shaft driven vehicle using the novel steam generator, expander drive and steam condenser of the invention.

### DESCRIPTION OF THE PREFERRED EMBODIMENTS

Before explaining the disclosed embodiments of the present invention in detail it is to be understood that the invention is not limited in its application to the details of the particular arrangements shown since the invention is capable of other embodiments. Also, the terminology used herein is for the purpose of description and not of limitation.

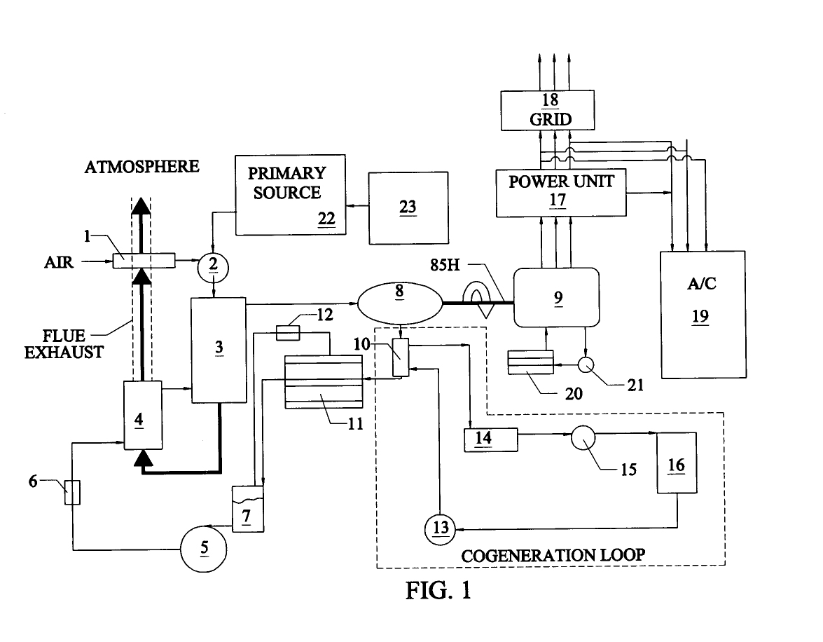

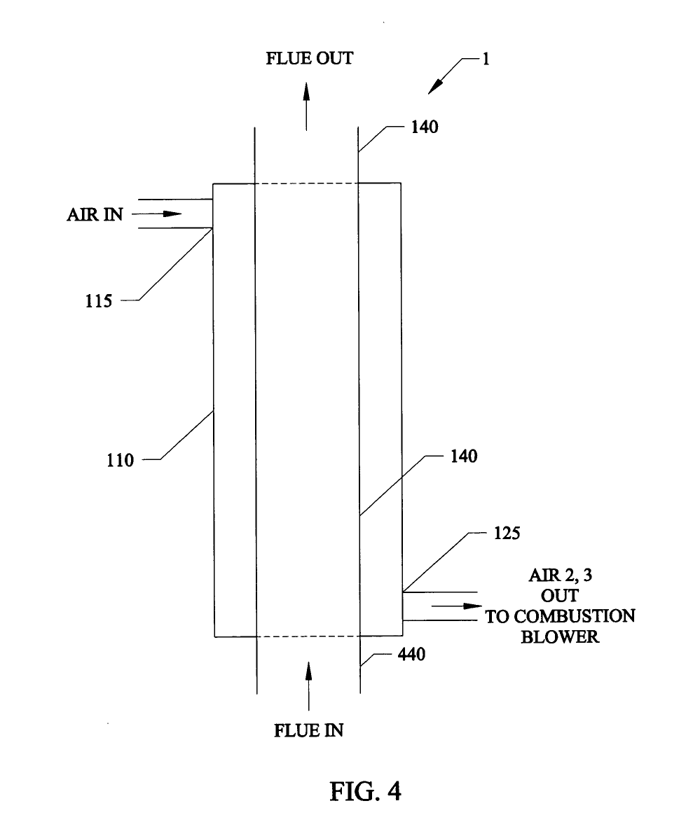

FIG. 1 is a flow chart diagram of a preferred embodiment system of the invention. Initially, ambient air comes through an air preheater (1 FIG. 1, shown in FIG. 4). The heated air is mixed with natural gas or propane in the airblower/valve assembly 2 FIG. 1 (such as but not limited to an AMETEK Variable Speed Power Burner Blower, or EBM, with gas metering devices such as those manufactured by Honeywell and Carl Dungs, and the like.) The airblower/valve assembly 2 supplies the air required for the combustion process from a primary fuel source 22. The forced air blower can be sized based on the application and/or requirements of the heat generator 3 FIG. 1. The gas metering portion of the airblower/valve assembly 2 provides the gaseous fuel (natural gas, propane, and the like.) required for the combustion process. This device can regulate the amount of gaseous fuel to provide the optimum stoichiometric air to fuel ratio (e.g. for natural gas, that ratio is approximately 10 to approximately 1). The gaseous fuel enters the forced air stream through the device. Alternative fuels can be used as a back up fuel source 23, if the current fuel supply is disrupted. The device can automatically shift to the back up source 23, such as but not limited to propane tanks, by switching to a different gas/air mixture and other adjustments which can automatically occur.

The invention can incorporate the latest in modulating blower, valve 2 and burner technology in heat generator (boiler) 3. This allows the proper air/gas mixture at all inputs determined by a feedback signal from the electric load placed on the electric generator 9.

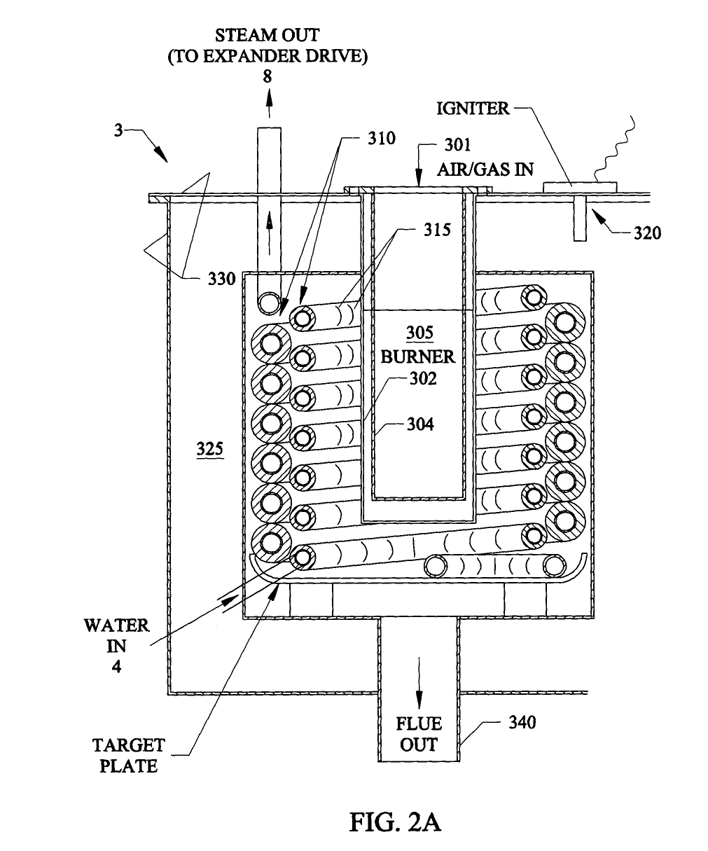

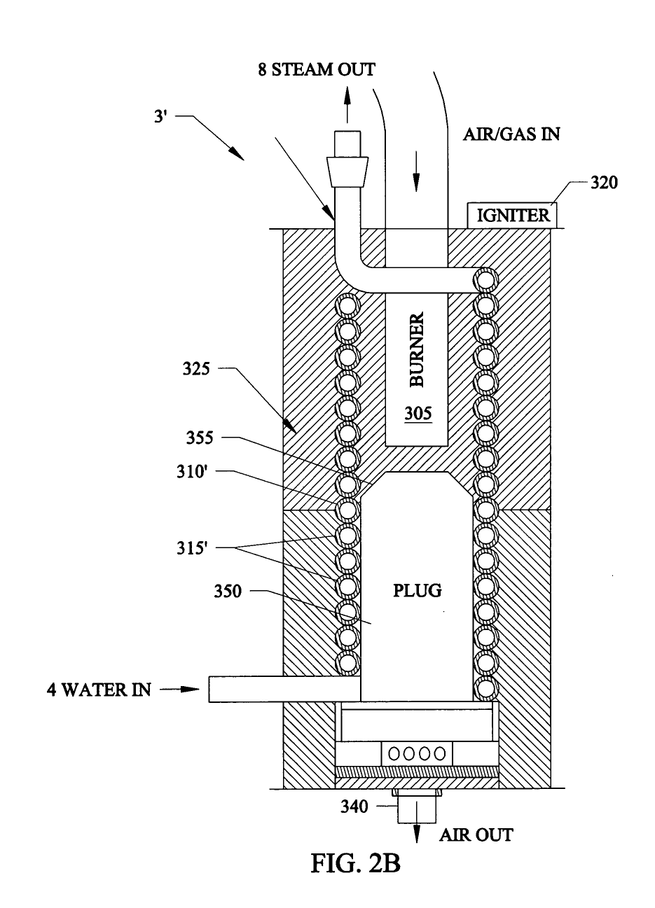

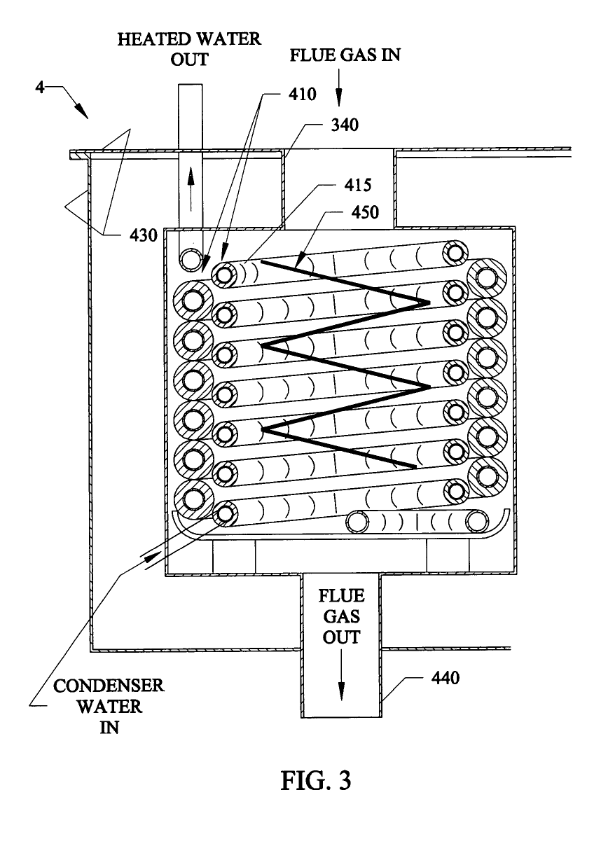

The proper gas air mixture (approximately 10 air to approximately 1 gas) is injected by blower 2 (a combination air blower fan and gas metering device) into a burner inside the heat generator unit (boiler) 3 FIG. 1 (shown in FIGS. 2A and 2B). Heated combusted gases heats the incoming water from the closed loop system (12, 11, 7, 5, 6, 4 FIG. 1). Exhausted flue gasses from boiler 3 pass through heat recovery 4 FIG. 1 (shown in FIG. 3), after heating incoming air exhausts into the atmosphere.

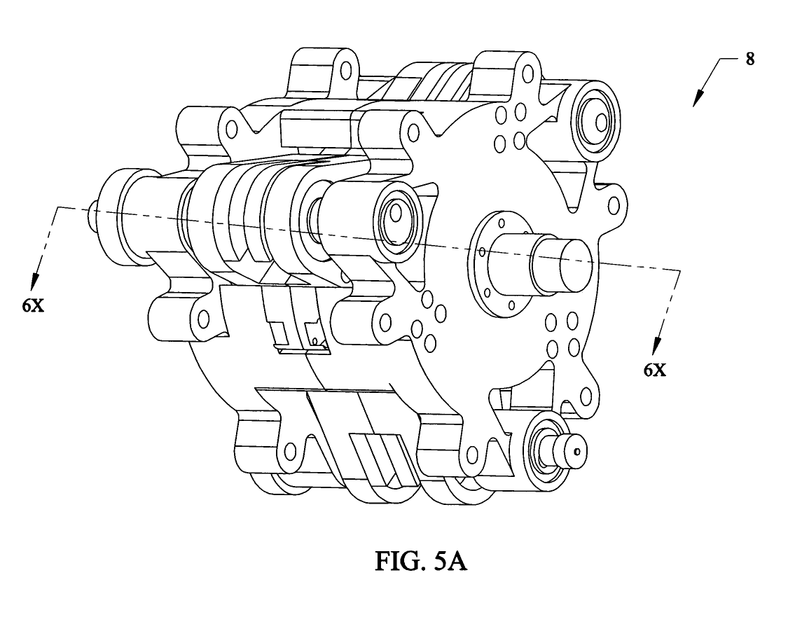

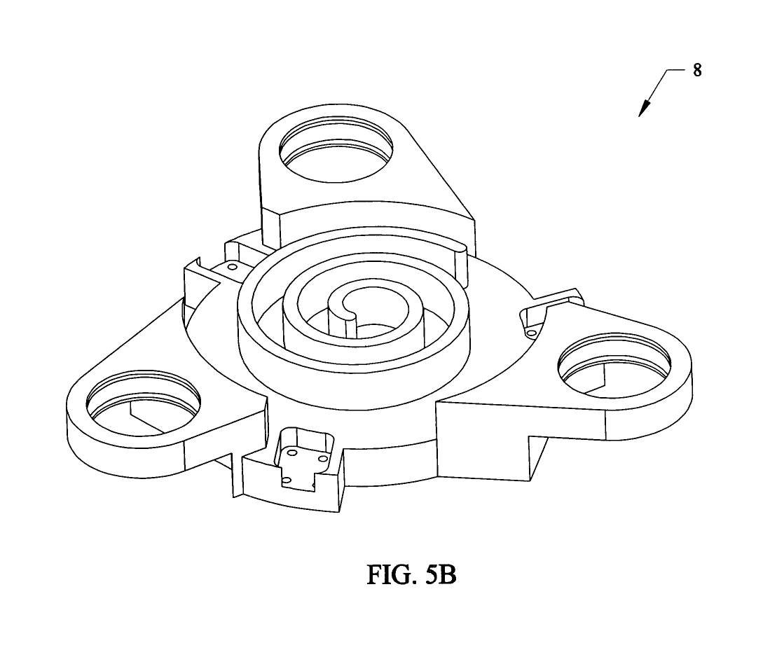

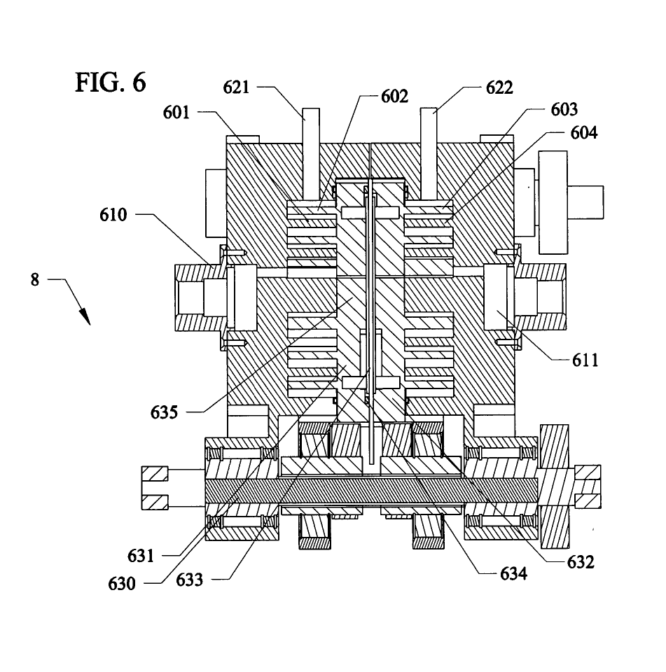

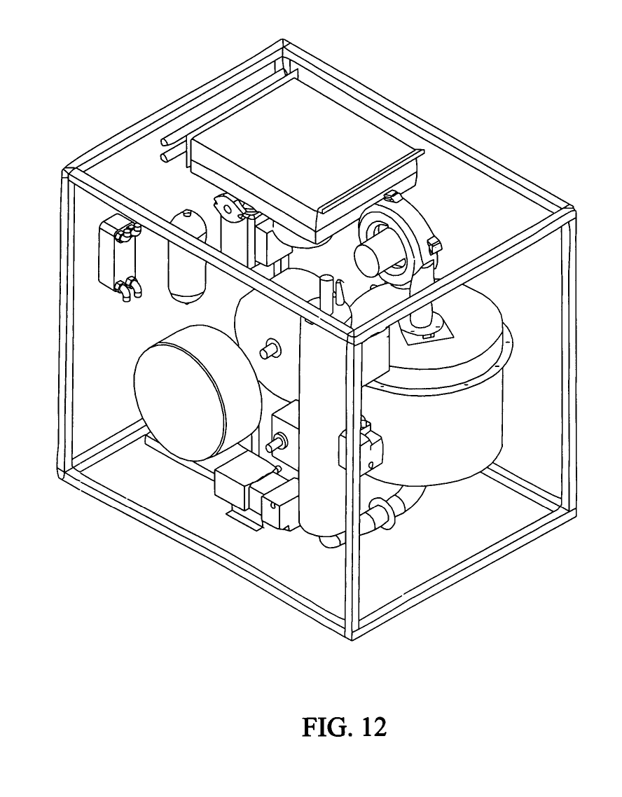

Steam generated in boiler (heat generator) 3 FIG. 1 (FIG. 2A or 2B) at a temperature of approximately 1000F and approximately 600PSI enters expander drive 8 FIG. 1 (FIGS. 5A, 5B and 6). This steam in expander drive 8 causes a shaft 8SH in the expander to turn, the shaft SH is connected to electric generator 9 FIG. 1 (FIG. 11). Electric generator 9 can be a commercial off the shelf generator (COTS) such as Light Engineering Inc., Marathon, e-Cycle. A preferred generator 9 can be a 240 Volt three-phase AC power supply, or 120 Volt single-phase AC power supply, and the like.

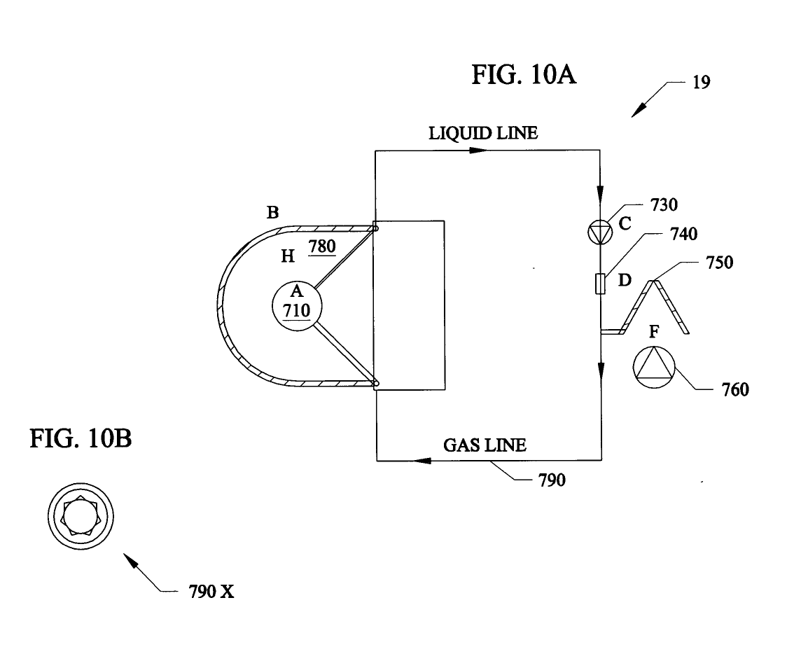

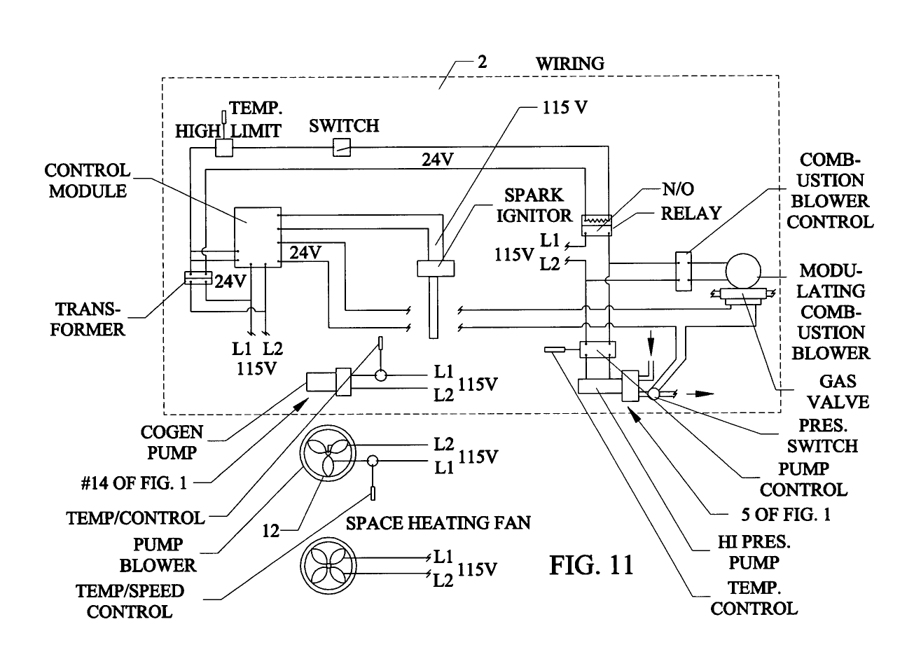

Referring to FIG. 1, electricity produced goes through a power conditioning unit 17 FIG. 1 such as those commercial off the shelf units that come with the electric generator 9 previously described, for the purpose of putting the electricity generated into the proper phase and frequency for feeding into an electrical power grid 18 FIG. 1. Electric power grid 18 can be an existing grid that supplies electrical power to commercial, industrial and residential applications, such as but not limited to FPL (Florida Power and Light) electric power supply grid. Also, electricity generated out of power conditioning unit 17 powers the air conditioner 19 FIG. 1 (FIGS. 10A-10B). The power conditioning unit 17, can be an off-the-shelf unit manufactured by Light Engineering Inc. which adjusts parameters such as phase and harmonics coming out of electric generator 9 and such as a standard AC to DC type converter, and the like.

Electrical generator heat dissipating units 20, 21 can consist of liquid pump and fan 21 and standard heat exchanger (for example, a radiator, tubes with fins, and the like) 20, for generator 9 FIG. 1 cooling and keeps generator at a temperature of approximately 130F or less. Pump portion 21 can be a fractional horsepower circulator of an anti-freeze solution, such as those manufactured by TACO, Grundfos, and the like. Fan portion 21 can be a pancake style blower of approximately 50 CFM (cubic feet per minute) operating at approximately 115 volts such as one manufactured by EBM, and the like. A heat sensitive speed controller (thermostat) such as one manufactured by Honeywell, and the like, can be built into the fan portion, to operate the fan.

Co Generation Loop.

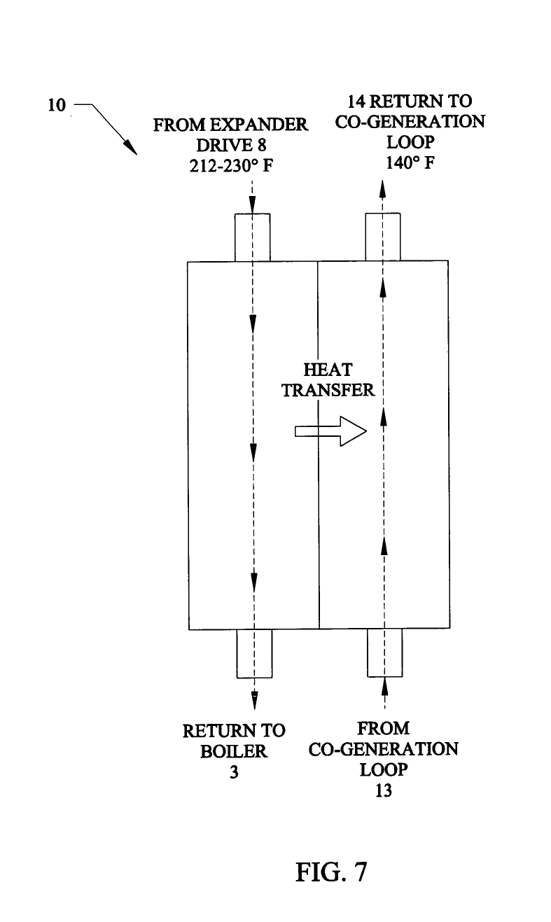

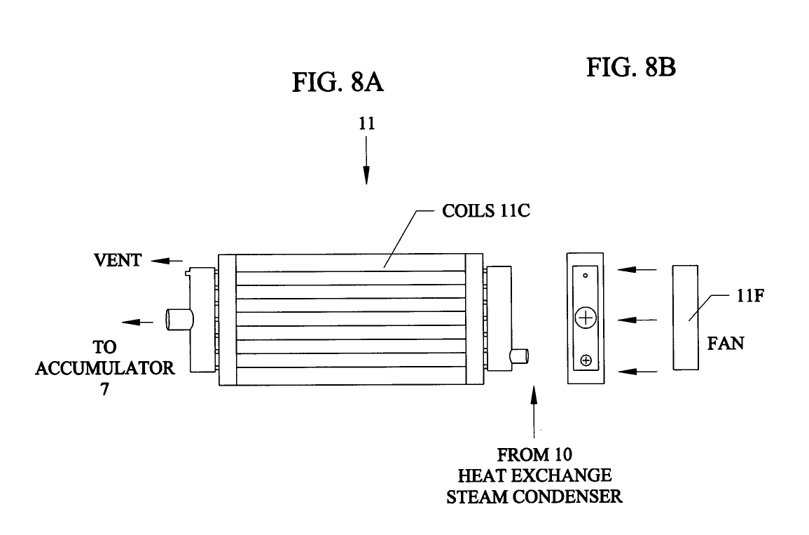

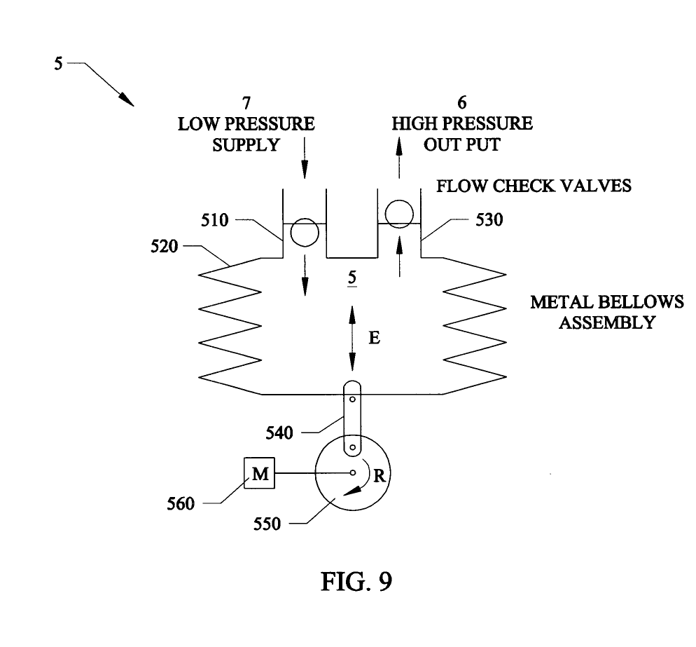

From Expander drive 8 FIG. 1 (FIGS. 5A, 5B and 6), the steam exhausted goes to a steam to water exchanger 10 FIG. 11 (FIG. 7) to a pump 14 (Off the shelf water circulator) to a domestic water heater 15, to a hot water air heating coil 16 such as a room/house hot water space heater (a coil passing through a fan) to other loads 13, such as but not limited to a swimming pool, a spa, underground pipes for ice and snow removal, and the like. Next, the same hot water passes back at a reduced temperature of up to approximately 30F, to heat exchanger 10 FIG. 1 (FIG. 7). When co generation loop is completely satisfied (i.e. all the hot water is heated up in domestic water heater 15, no more heat is required for heating house 16, pool/spa is at desired temperature) then in order to dissipate any excess heat, it passes from heat exchanger 10 to steam dissipation coil 11 FIG. 1 (FIGS. 8A-8B), where condensed water is placed into accumulator 7 (water storage tank) by way of dissipation coil and the pressure balancing vent check valve, which relieves built up vapor. Then, the high pressure condensate return pump 5 FIG. 1 (FIG. 9) pumps water to check valve 6 (keeps water from going backward). Pump 5 can run at approximately 600 to approximately 1,000 psi. Water is then passed to heat recovery unit (reclaimer) 4 FIG. 1 (FIG. 3). Water can be heated in recovery unit (reclaimer) 4 and is pumped by a high pressure pump 5 into steam generator (boiler) 3 for heating back into steam to complete the cycle of the entire system, where heat generator (boiler) 3 can operate at a temperature of approximately 1,000 F to approximately 1,500 F.

In the cogeneration loop of FIG. 1, steam exits the expander drive 8 at a temperature at approximately 212F to approximately 230F. This steam passes through the steam to water exchanger 10 (FIG. 7), such as but not limited to a Alfa Laval CB-14 a COTS item to extract the heat of the steam and transfer it to the co generated water to be used for domestic hot water, heating water to be used for domestic hot water 15 for heating water and other water usages 13 such as but not limited to pools, snow melting, and the like. This co generated water is pumped by a COTS circulator pump 14, such as but not limited to a Taco or Grundfos pump, and the like. In a situation where all co generated heat usages are satisfied, the excess heat (steam) continues on to the heat dissipation coil 11, such as one manufactured by Heatcraft or other steam condenser manufacturers.

The condensed steam is now changed to water, which gave up its latent heat to the co generated water. The closed loop steam, now water, is transferred to the accumulator 7 passing through check valve 6 ready to be returned to the heat generator 3 by the high pressure bellows pump 5 (FIG. 9).

FIG. 2A is a cross-sectional view of a dual wrap fin coil heat generator (boiler) for the embodiment of FIG. 1, and can be used for compact spaces when space restricts height dimensions of a boiler. Air blower (2 FIG. 1) forces an air/gas fuel mixture to enter burner. Gas/fuel meter in blower/meter 2 (FIG. 1) provides the gaseous fuel (natural gas, propane, and the like) from primary fuel source 22 (FIG. 1) required for the combustion process. This device will regulate the amount of gaseous fuel to provide the optimum stoichiometric air to fuel ratio (e.g. for natural gas, that ratio is 10 to 1). The gaseous fuel enters the forced air stream. Alternative fuels from a backup fuel source 23 (FIG. 1) can be used as a back up if the current fuel supply is disrupted. The device can automatically shift to the back up source 23, such as but not limited to propane tanks, by switching to a different gas/air mixture and other adjustments can be made automatically.

The burner screens 302, 304 located inside the body of the heat generator 3, is where the fuel and air mixture is ignited and burned. The burner 305 consists of two cylindrical (inner and outer) screens 302, 304. The purpose of the dual screens 302, 304 is to prevent flashbacks from the combustion of the fuel and air mixture. The screens 302, 304 can be made of Inconel or other high temperature materials, and the like.

Referring to FIG. 2A, heat exchanger (double wrapped fin tubes 310) are wrapped around the burner 305 and can be constructed of approximately 5/8″ 321 stainless steel tubing with external outwardly protruding fins 315. The working fluid (water) is pumped through the heat exchanger (by pump 5 FIGS. 1, 9 at approximately 600 to approximately 1000 psi), where it is heated from an approximately 150° F. to 250° F. entering temperature to a leaving temperature of approximately 1000 to approximately 1300° F. (nominal, approximately 1500° F. maximum) at approximately 1000 PSI. Once the working fluid is heated it will then go to the expander drive 8(FIGS. 5A, 5B and 6).

An electrically powered igniter module 320 attached to the heat generator 3 adjacent to air/gas inlet line 301 can provide the necessary energy (spark) to start the combustion process. The insulation 325 within heat generator housing 330 retains the heat that is generated during the combustion of the fuel and air mixture within the heat generator cavity to maximize the heat transfer to the heat exchanger (wrapped tubes 310). The insulation 325 can be composed of aluminum/silica or other high performance insulation, and the like. Exterior outer generator housing 330 can be composed of stainless steel, aluminum, high temperature plastic, and the like, and houses the insulation 325, heat exchanger 310, and burner screens 302, 304.

A downwardly extending flue 340 exhausts the products of combustion (flue gases). The flue gases, which are very friendly to the environment are primarily carbon dioxide and water vapor with trace amounts (ppm) of CO and very low (less than 10 ppm NOₓ. A minimal amount of heat (≦approximately 2% of total heat generated) is also lost through the flue. The flue gases can be harmlessly exhausted to the atmosphere.

Water entering heat generator (boiler) 3 FIG. 1, FIG. 2A from heat recovery (reclaimer 4 FIG. 1) is pumped to flow through the double wrapped finned coiled heat exchanger tubes 310, and exits the boiler at approximately 1000F to approximately 1500F to pass to the expander drive 8 FIGS. 1, 5A, 5B and 6.

FIG. 2B shows a cross-sectional view of a single wrap fin coil heat exchanger (boiler) 3′ for the embodiment of FIG. 1 that can be used where height restrictions are not a problem. In FIG. 2B, a plug 350 such as a high temperature insulation material previously described is positioned below a burner, and is used for directing the forced air combustion against the exterior fins on the single layer of wrapped fin covered coil tubes 310′. The upper end 355 of the plug 350 can be chamfered/taperered, and can be conical, and the like. Air swirls and turbulates about the fins 315′ which are about the coil tubes 310′ to maximize heat transfer from the burner 305 to the water circulating through the coils 310′. The function of other components in FIG. 2B is similar to those described in reference to FIG. 2A The heat generators 3 and 3′ of FIGS. 2A-2B produce steam to provide motive power to the system expander. FIG. 2A uses a mono-tube 310 wrapped about it itself, and FIG. 2B is a single wrap mono-tube 310′. The mono-tube 310/310′, has a very small fluid capacity (0.64 gallons of distilled water). Any leakage would release the steam without any explosive power and therefore is a safe device even at the operating pressure of approximately 600 to approximately 1000 psi and temperatures of approximately 1000 to approximately 1300F with a maximum of approximately 1500F. The pressure drop would immediately shut off fuel supply and stop the system operation.

The forced combustion blower and a modulating gas valve 2 FIG. 1, are controlled by the ignition module 320 in FIGS. 2A-2B, which delivers a mixture of fuel gas and air to the burners 305 within the heat generator (boiler) 3, 3′ of FIGS. 2A, 2B. The burner 305 can be one manufactured by Burner Systems Inc. or Cleveland Wire Cloth, where the combustion takes place on the burner surface 302, 304 to heat the water to steam in the heat generator tubes 310, 310′.

The tubes 310, 310′ in the heat generators 3, 3′ of FIGS. 2A-2B can include approximately 0.018, thick 316 stainless steel fin material of approximately 0.125 height and approximately 0.25 height wrapped and brazed around at approximately 14 to approximately 11 fins per inch. An approximate 0.625 ID (internal diameter), tube of 321 stainless steel of approximately 0.083 wall as required to meet the required pressure vessel codes.

Referring to FIGS. 2A-2B, heat can be absorbed by the helix (helical) coil tubes 310, 310′ from radiation from the burner flame in burner 305 and from convection of the products of combustion of forced combustion burner 305, to produce output steam flow rate of approximately 95 pounds per hour at approximately 600 psi and approximately 1000F.

Water in the heating coils 310, 310′ can be heated through the saturated steam range into the superheated steam range realm all in one heat generating path as opposed to standard methods using two stage steam systems with a separate super heat section.

FIG. 3 shows the heat recovery unit (liquid condensate heat exchanger) 4 for the embodiment of FIG. 1. Flue gas from bottom extending flue 340 passes into a chamber having double wrapped mono-tube finned 410 heat exchanger, and maximizes heat efficiency to water passing through the double wrapped tubes 410 within a housing 430 (similar in material to the housing 330 of the heat generator 3. The Liquid Condensate Heat Exchanger (Reclaimer) 4 captures waste heat in the flue 340, which adds to the overall efficiency of the invention. This heat exchanger 4 can be constructed of 321C stainless steel tubing 410 with 316 stainless steel external fins 415.

The flue heat reclaimer 4 in FIG. 3 captures heat from the flue gas exhaust to raise the temperature of the water from the steam condenser 10 FIG. 1 before it is pumped by the high pressure pump 5 FIG. 1 into the heat generator 3 FIG. 1.

The flue heat reclaimer built of the same materials as the heat generator 3 FIG. 1 and able to withstand the pressure that exists in the heat generator 3: A spiral baffle 450 can be used to distribute the flue heat to all the tubes 410 for proper heat transfer.

FIG. 4 shows air preheater component 1 for the embodiment of FIG. 1. A combustion air pre-heater increases the efficiency of the combustion burner 205 of FIGS. 2A, 2B by capturing the heat usually wasted in the flue 440, 140. Energy needed to heat the air in combustion is lowered, increasing the efficiency of the overall system. The pre-heater 110 can be made of stainless steel materials for long life. Ambient air can be pulled into an opening 115 in the annular chamber 110 surrounding the flue 440, 140, by a combination fan/blower and gas valve 2 FIG. 1 pulling the heated air out of opening 125 to be directed into the heat generator (boiler) 3 FIG. 1.

FIG. 5A is a perspective view of an expander drive 8 for the embodiment of FIG. 1. FIG. 5B is an internal view of the expander drive of FIG. 5A. FIG. 6 is a cross-sectional view of the expander drive of FIG. 5A along arrows 6X.

The expander drive 8 converts the thermal energy of the working fluid into mechanical (rotational) energy to drive the generator or any other mechanical device.

FIGS. 5A, 5B and 6 show an expander drive system based Scroll Labs “floating scroll” technology (see U.S. patent Ser. No. 10/342,954 to one of the inventors of the subject invention, which is incorporated by reference) for the subject invention. The scroll device 8, used as compressors, expanders and vacuum pumps, are well known in the art. In traditional scroll device there is a set of scrolls including one fixed scroll and one orbiting scroll making circular translation, orbiting motion, relative to the former to displace fluid. In a floating scroll device there are two sets of scrolls, front and rear scrolls. Each set of scrolls, front or rear, consists of a fixed scroll and an orbiting scroll. Floating scroll technology adopts dual scroll structure. FIG. 5A is a perspective view of the external appearance of a floating scroll expander drive 8. FIG. 5B is an exploded view of the expander drive 8 of FIG. 5A which shows the internal orbiting scroll of floating scroll expander drive.

Referring to FIG. 6 the working principle of the floating scroll expander drive is explained. Front fixed scroll 601 and rear fixed scroll 604 are engaged with front orbiting scroll 602 and rear orbiting scroll 603, respectively. The front and rear orbiting scrolls of the dual scroll are arranged back to back and orbit together and can make radial movement relative to each other during operation.

For simplicity, below we will only describe the working principle of the front scrolls. The working principle of the rear scrolls is similar. The steam enters the expander drive 8 from the inlet port 610 at the center of the front fixed scroll. The steam is then injected into the expansion pockets formed between the scrolls and is expanded during the orbiting motion of the scrolls, and finally, discharges through passage 620 and discharge port 621 at the peripheral portion of the front fixed scroll. There are three substantially similar and uniformly distributed crankshafts (only one 630 is shown). The crankshafts serve three functions: driving, anti-rotation and axial compliance. The one or more crankshafts convert the orbiting motion of the orbiting scroll in to rotation and then drive a generator to produce electricity. The three crankshafts work together to prevent the orbiting scroll from rotation. The crankshafts also allow the orbiting scroll to move axially, (axial compliance), to maintain the radial seal between the tips and bases of the scroll.

Referring to FIG. 6, the front and rear orbiting scrolls 602 and 603 have front end plate 631 and 632, respectively. There is a plenum chamber 633 formed between the two end plates. Sealing element 634 seals off plenum chamber 633 from surrounding low-pressure area. The plenum chamber 633 is connected to a selected position of expansion pocket formed between the fixed and orbiting scrolls through a passage 635. The forces of the steam acting on the area in the plenum chamber 633 slightly exceed the total axial forces acting on the opposite surface of the front orbiting scroll 602 by the expanding steam. The net axial forces will urge the front orbiting scrolls towards the front fixed scrolls to achieve very light contact between the tips and bases of the mating scrolls 601 and 602. This axial compliant mechanism enables a good radial sealing between expansion pockets and makes the wear between the orbiting and fixed scrolls negligible and self-compensating.

In the floating scroll, a crankshaft synchronizer 636 is used to keep the orientation of three crankshafts being synchronized. Therefore the orbiting scroll is able to move in the radial direction and keep the flank to flank contact of the spiral walls of the mating scrolls. This is called radial compliance, which enables good tangential seal between expansion pockets formed between the mating scrolls.

The axial and radial compliant mechanisms enable the orbiting scrolls to be dynamically balanced, yet lightly contacting mating fixed scroll to achieve good and lasting seal for high efficiency and durability. We called it floating scroll technology.

FIG. 7 shows the steam to water exchanger (Co Generation Steam condenser) 10 for the embodiment of FIG. 1. The invention uses a plate fin exchanger to extract heat from the exhaust of the expander to heat water for co generation usages of domestic hot water, hot water space heating and other incidental usages. The exchanger 10 can be small in size, but able to extract all of the co generated hot water that is available, and can be one manufactured by Alfa Laval, such as model # TK 205411G01. The exchanger 10 allows for fluid flow on one side from expander drive 8 coming in at approximately 212° F. to approximately 230° F. at approximately 2 to 60 psi and going out another end to heat dissipation coil 11 and eventually to return to heat generator (boiler) 3 The other side of the heat exchanger 10 has an opposite flow path with fluid flowing in from co-generation loop 13 (from other loads) and out other end to co-generation recirculation pump 14 at a temperature of approximately 140F.

FIG. 8A shows a side view of the steam dissipation coil (heat dissipation steam condenser) 11 for the embodiment of FIG. 1, and includes a coil and fan assembly FIG. 8B is an end view of the coil and fan assembly of FIG. 8A. The steam dissipation coil provides a method of dissipating excess heat and condensing the steam from the expander drive 8 when all co generated heat has been satisfied. This allows the invention system to continue operating and providing electricity to the power grid 18 on a 24 hours-a-day, seven days-a-week basis. The condensate coil 11 can be manufactured by Heatcraft or other fin and tube manufacturers, and is used for the closed loop system, and can be made of stainless steel tubes with aluminum fins. The coils 11C allows for dissipation of excess heat, which cannot be utilized in the co-generation loop in FIG. 1.

The heat rejection fan assembly 11F used in the steam dissipation application can be a modulating speed motor blower assembly controlled from a heat level feed back from the steam dissipation coil. This can be an off-the-shelf fan device of 115 volt, 1/6 horsepower, 1725 RPM with a 16-inch propeller fan putting out 1600 CFM at maximum condition. Air flows from the fan 11F through the coils 11C that are about the flow path lines inside the coil assembly 11.

FIG. 9 shows the configuration of the condensate return pump (high pressure return pump) 5 for the embodiment of FIG. 1. Low pressure fluid coming from accumulator (water tank) 7 FIG. 1 passes into the metal bellow assembly by line 510. The adjustable eccentric drive expands and compresses the metal bellows 520 along double arrow E, producing a high pressure output supply of liquid which passes to check valve 6 out line 530 back to reclaimer 4 and then to heat generator (boiler) 3 FIG. 1A fractional electric horsepower motor, M, 560 can be used to rotate an adjustable eccentric wheel drive 550 in the direction of arrow R which can be used to expand and compress the metal bellows pump 520 by a piston type connector 540.

This high pressure, low volume pump 5 can provide approximately 600 plus PSI condensate water back into the high pressure boiler supply 3. Bellows pump 5 allows for boiler input conditions greater than or equal to approximately 600 PSI, greater than or equal to approximately 200 F, and a mass flow of 95 pounds per hour.

Primary description provides seamless high pressure low volume pumping of condensate (steam turned back to water) in boiler supply circuit (5, 6, 4, 3 FIG. 1).

FIG. 10A shows a top view the air conditioner unit and system 19 for FIG. 1. The A/C module unit 19 can consist of variable speed compressor 710, condenser coil 720, refrigerant pump 730, expansion valve 740, evaporator coil 750, variable fan (blower) 760, and variable speed fan (blower) 780. This unit 19 is a straight A/C unit, not a heat pump, as the heat required by the home will be taken from the cogeneration loop of the invention in FIG. 1.

The air conditioner unit/system 19 can be a high efficiency (approximately 20 SEER) rated to operate on the lowest amount of fuel source needed. The compressor can either be a straight electrically-driven compressor or mechanically driven from the expander drive 8, and can include:

1. Refrigerant tubes 790 in the condenser and evaporator can have rifled interior surfaces with added tube turbulators (see 790X).

2. Both condenser and evaporator can have variable fan controls to match the loads required by the usage.

3. The compressor can be an advanced scroll that can be modulated according to usage needs.

4. A liquid refrigerant pump and matched expansion valve can be used for greater system efficiency.

5. A quiet and energy-efficient condenser and evaporator fan blades can be used. This can be an off-the-shelf item such as one manufactured by Jet Fan using the Coanda effect.

6. A complete model line of approximately 2½ to approximately 5 tons can be available in single and three phase electric input.

The A/C module can have the highest SEER (Seasonal Energy Efficiency Ratio) rating and lowest cost and will be more reliable than any high-efficiency A/C units in the market today. The operation of the A/C unit and system 19 will now be described in reference to FIG. 10A.

Starting at heat absorbed from the interior environment by the evaporator coil 750. Air from the interior of a space can be blown over the rifled tube evaporator coil 750 by the variable speed blower (fan) 760. The refrigerant in absorbing heat has been changed to gas. This low pressure gas continues to the air conditioning variable speed compressor 710. A suction accumulator (not shown) can be added to prevent liquid from entering the compressor 710. The compressor 710 intakes the low pressure heated gas to a high pressure heated gas adding the heat of compression. This heated refrigerant gas enters the novel rifled tube (detail 790X shown in FIG. 10B), which causes a turbulated effect inside tube 790 where ambient air (outside air) induced by the quiet blade fan of blower 780 cools the gas into a liquid. This liquid, under pressure from the compressor 710 is further increased in pressure by a liquid refrigerant pump 730 to increase efficiency. This liquid then enters a thermal expansion valve 740, where it is expanded through an orifice into evaporator 750 removing heat from the interior environment of the space being cooled by A/C unit and system 19 to complete the cycle.

FIG. 11 shows a wiring diagram for various components for FIG. 1. Referring to FIGS. 1 and 11, the heat rejection fans used in the steam dissipation coil assembly 11 can be controlled by a modulating speed motor blower assembly controlled from a heat level feedback from the steam dissipation coil in the dissipation coil assembly 11. The assembly 11 can include a 115 volt, 1/6 horsepower, 1725 RPM with a 16 inch propeller fan putting out 1600 CFM at maximum condition.

The heat rejecter for cooling the electric generator 9 in FIG. 1 includes a fractional HP circulator of an antifreeze solution (TACO or Grundfos), 115 volts. A pancake blower of 50 CFM (EBM) or similar, 115 volts, with a heat sensitive speed controller (Honeywell) or similar, 115 volts.

Referring to FIGS. 1 and 11, the control module 17, can be an off-the-shelf product manufactured by Honeywell, Invensys, or Varidigm, and is controlled by a 115 volt input and puts out a 24 volt signal through a high limit switch. This module also controls the gas ignition device, either a hot surface igniter or spark igniter of 115 volts. Through an internal or external relay it controls the modulating combustion blower and modulating gas valve. It also controls the high-pressure condensate pump and the electric generator cooling circulating pump. This pump modulates according to a temperature signal of the circulating fluid. On separate 115 volt circuits, heat signal modulating fans control the co generation pump, the heat dissipation coil blower fan and the space heating fan in the air conditioning unit evaporator cabinet. The air conditioning unit 119 has its own modulation circuit as described in the air conditioning description previously described.

FIG. 12 shows a perspective view of a preferred layout of all the components of the invention in a 3′ by 4′ by 5′ box for use by the end user of the invention.

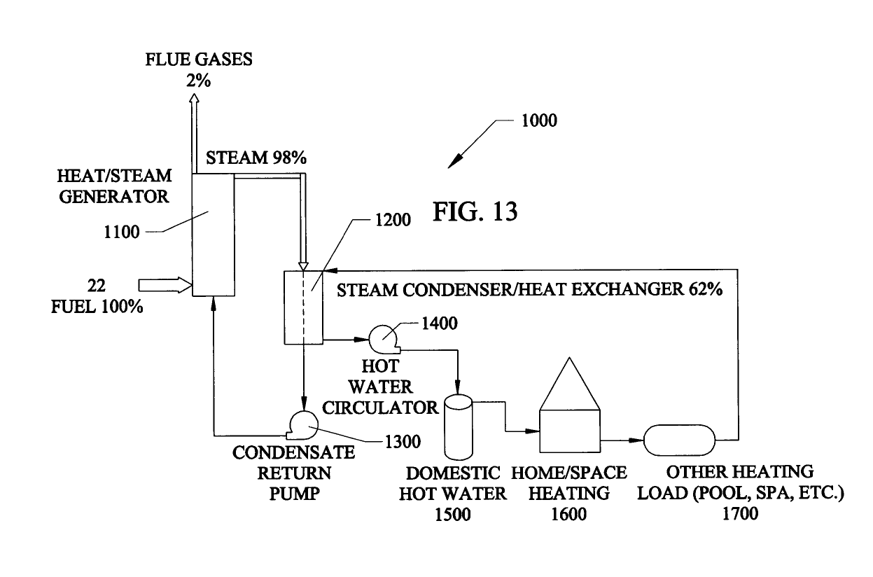

FIG. 13 shows a second preferred embodiment 1000 for heat generation using a closed loop steam generator system 1200, 1400, 1500, 1600, 1700. The steam generator (boiler 8) 1100 referenced above in FIGS. 2-3 turns water into steam by burning a fuel source (22 FIG. 1) such as natural gas, propane, and any vaporous fuel. Generated steam has a temperature of approximately 280 to approximately 1000 degrees, and a pressure range of approximately 100 to approximately 600 psi. The generated steam has an efficiency rating of turning water into steam of up to approximately 98%, with flue gases making up the remaining approximately 2%. The steam enters a steam to water condenser exchanger 1200 (10 FIG. 7) where the steam is changed back to water and pumped back into the heat (steam) generator by high pressure condensate return pump 1300 (5 FIG. 9).

Operation of novel closed loop heat cycle. From the condenser heat exchanger 1200 water passes to hot water circulator 1400 (such as off-the-shelf water pump) to supply domestic hot water 1500 (through a domestic hot water type heater) at temperature ranges of approximately 120 to approximately 140F. Additionally, the pump 1400 supplies the hot water to home and/or space heating 1600 (such as but not limited to radiator, base board, radiant in-floor heating pipes, or forced air or hot water/forced air systems) at similar temperatures). Additionally, other heating loads 1700, such as but not limited to pool heating, spa heating, underground pipes for snow/ice removal, and the like. After which the water is returned to condenser heat exchanger 1200 at a lower temperature of approximately 20 to approximately 30 degrees lower than the outgoing heated water temperature passing through hot water circulator pump 1300.

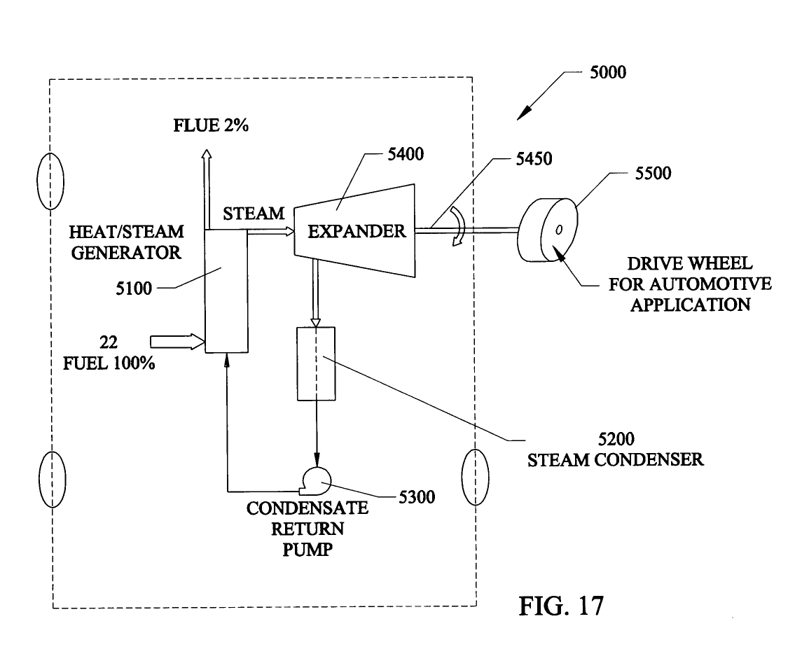

The preferred layout of FIG. 17 achieves up to an approximate 98 percent efficiency while standard safety codes (ASTME, American Society of Testing Material Engineers) is complied with. Additionally, the layout can be sized to be fit into a space of less than 2 by 1 by 1-foot space.

The simplicity and reduced parts in the system of FIG. 17 is can continuously run 24 hours a day seven days per week up to approximately 50,000 hours or more before any maintenance is needed, and does not require any lubrication for the system.

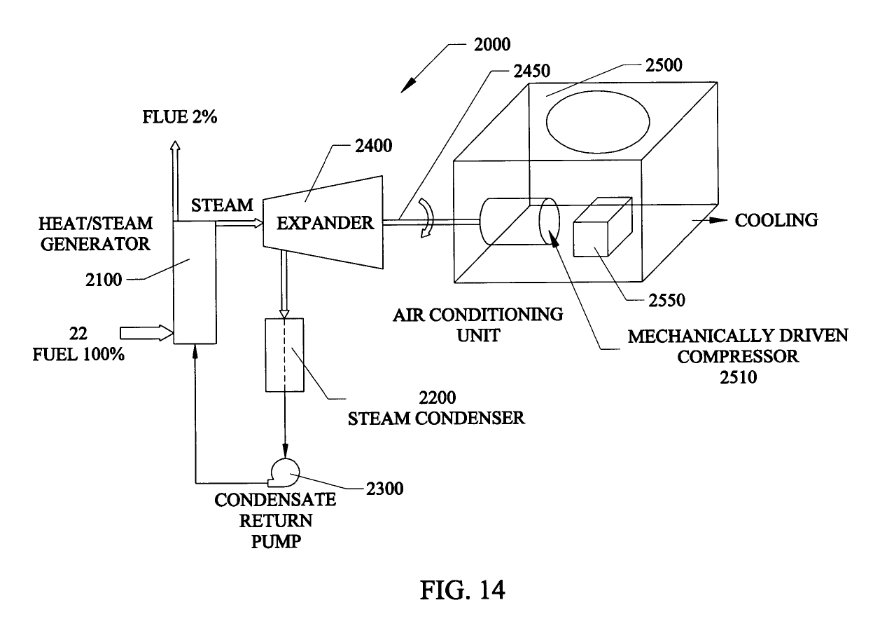

FIG. 14 shows a third preferred embodiment 2000 for powering an air-conditioner unit using the novel steam generator 2100, expander 2400 (8 FIGS. 5A, 5B, 6) and steam condenser 2200 of the invention, which is a vaporous fuel supplied air conditioner. The steam generator 2100 referenced above in FIGS. 2A-2B turns water into steam by burning a fuel source such as natural gas, propane, or any vaporous fuel. Generated steam has a temperature of approximately 280 to approximately 1000 degrees, and a pressure range of approximately 100 to approximately 600 psi. The generated steam has an efficiency rating of turning water into steam of up to approximately 98%, with emitted flue gases making up the remaining approximately 2%. The steam enters expander drive 2400 (described above in reference to FIGS. 5A, 5B, and 6), which rotates output driveshaft 2450 which is mechanically connected to a direct drive compressor 2510 such as but not limited to a Copeland Inc. shaft driven compressor, a Tecumseh Inc. shaft driven compressor, and the like. The shaft driven compressor 2510 is connected to standard components in a standard air conditioning unit 2550 (fan, condenser and motor for supplying cooled air), such as but not limited to those manufactured by Trane, York, Carrier, and the like. Compressor 2510 and airconditioner unit 2550 can be held in a single housing 2500.

Steam exiting the expander drive 2400 passes to a steam to water/air condenser exchanger 2200 (10 FIG. 7), where the steam is changed back to water back into the heat (steam) generator 2100 (boiler 8 FIGS. 2A, 2B) by high pressure condensate return pump 2300 (5 FIG. 9).

The preferred layout 2000 of FIG. 18 achieves up to an approximate 98 percent efficiency of the combined expander, steam condenser and steam generator, and these components can fit into a space of less than 3 by 1 by 1 foot space. The simplicity and reduced parts in the system of FIG. 18 can continuously run 24 hours a day seven days per week up to approximately 50,000 hours or more before any maintenance is needed, and does not require any lubrication for the system.

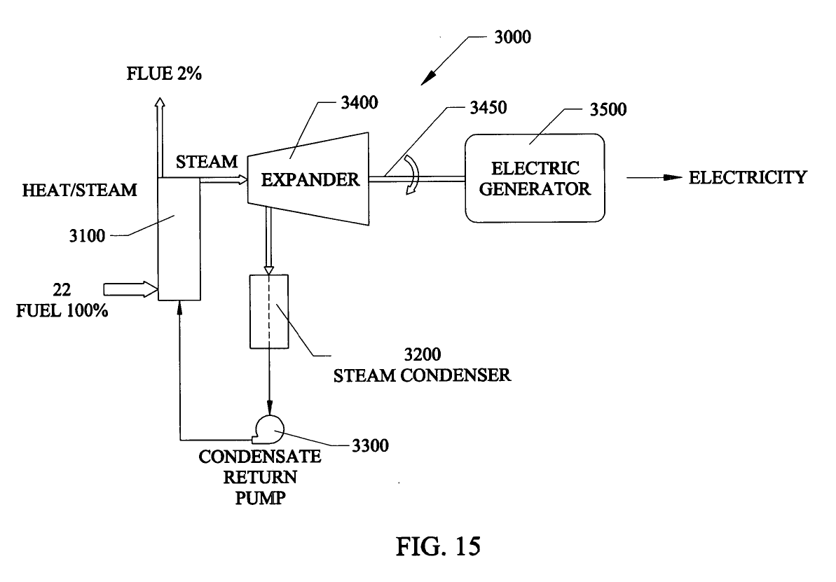

FIG. 15 shows a fourth preferred embodiment 3000 for supplying electricity to any electrically-powered device or system using the novel steam generator 3100 (boiler 8 FIGS. 2A, 2B), expander drive 3400 (8 FIGS. 5A, 5B and 6) and steam condenser 3200 of the invention. The steam generator 3100 referenced above in FIGS. 2A-2B turns water into steam by burning a fuel source 22 such as natural gas, propane, or any vaporous fuel. Generated steam has a temperature of approximately 280 to approximately. 000 degrees, and a pressure range of approximately 100 to approximately 600 psi. The generated steam has an efficiency rating of turning water into steam of up to approximately 98%, with emitted flue gases making up the remaining approximately 2%. The steam enters expander drive 3400 (described above in reference to FIGS. 5A, 5B and 6)), which rotates output driveshaft 3450 which is mechanically connected to an shaft driven electrical generator 3500 such as but not limited to SmartGen 70-32W Generator by Light Engineering Inc., Marathon Generator, e-Cycle Generator, and the like.

Steam exiting the expander drive 3400 passes to a steam to water/air condenser exchanger 3200(10 FIG. 7), where the steam is changed back to water back into the heat (steam) generator 3100 by the high pressure condensate return pump 3300 (5 FIG. 9).

The preferred layout of FIG. 19 achieves up to an approximate 98 percent efficiency of the combined expander, steam condenser and steam generator, and these components can fit into a space of less than 3 by 1 by 1 foot space.

The simplicity and reduced parts in the system of FIG. 19 can continuously run 24 hours a day seven days per week up to approximately 50,000 hours or more before any maintenance is needed, and does not require any lubrication for the system.

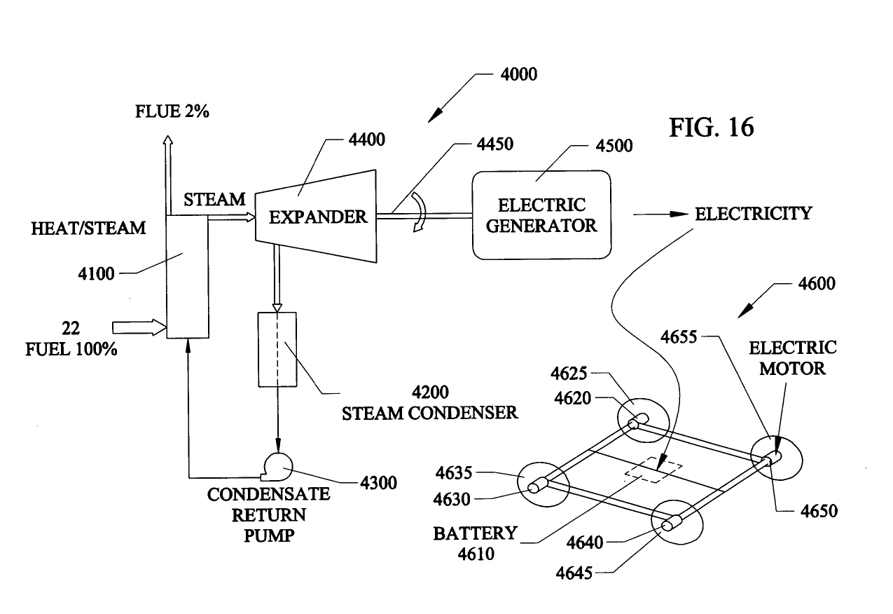

FIG. 16 shows a fifth preferred embodiment 4000 for supplying electrical power to an electric vehicle 4600, such as an electric car using the novel steam generator, expander and steam condenser of the invention. The steam generator 4100 referenced above in FIGS. 2A-2B turns water into steam by burning a fuel source 22 such as natural gas, propane, and any vaporous fuel. Generated steam has a temperature of approximately 280 to approximately 1000 degrees, and a pressure range of approximately 100 to approximately 600 psi. The generated steam has an efficiency rating of turning water into steam of up to approximately 98%, with emitted flue gases being up to the remaining approximately 2%. The steam enters expander drive 4400 (described above in reference to FIGS. 5A, 5B and 6), which rotates output driveshaft 4450 which is mechanically connected to an shaft driven electrical generator 4500 such as but not limited to SmartGen 70-32W Generator by Light Engineering Inc., Marathon Generator, e-Cycle Generator, and the like.

The electric generator 4500 can supply electricity to a vehicle battery 4610 which can be connected to electric motors 4620, 4630, 4640, 4650 that rotate axles about wheels 4625, 4635, 4645, 4655 of a vehicle 4600 such as a car, and the like.

Steam exiting the expander driver 4400 passes to a steam to water/air condenser exchanger 4200 (10 FIG. 7) where the steam is changed back to water and pumped back into the heat (steam) generator by the high pressure condensate return pump 4300 (5 FIG. 9).

The preferred layout 4000 of FIG. 20 achieves up to an approximate 98 percent efficiency of the combined expander, steam condenser and steam generator, and these components can fit into a space of less than 3 by 1 by 1 foot space The simplicity and reduced parts in the system of FIG. 21 can continuously run 24 hours a day seven days per week up to approximately 50,000 hours or more before any maintenance is needed, and does not require any lubrication for the system.

FIG. 17 shows a sixth preferred embodiment 5400 for powering a drive shaft driven vehicle using the novel steam generator 5100, expander driver 5400 and steam condenser 5200 of the invention. The steam generator 5100 referenced above in FIGS. 2A-2B turns water into steam by burning a fuel source 22 such as natural gas, propane, and any vaporous fuel. Generated steam has a temperature of approximately 280 to approximately 1000 degrees, and a pressure range of approximately 100 to approximately 600 psi. The generated steam has an efficiency rating of turning water into steam of up to approximately 98%, with emitted flue gases making up the remaining approximately 2%. The steam enters expander driver 5400 (described above in reference to FIGS. 5A, 5B and 6), which rotates output driveshaft 5450 which is mechanically connected to a drivetrain/axle or which rotates an axle to a wheel(s) 5500 on a vehicle 5000 such as a car, and the like.

Steam exiting the Expander driver 5200 passes to a steam to water/air condenser exchanger 5200 (5 FIG. 7), where the steam is changed back to water and pumped back into the heat (steam) generator 5100 by the high pressure condensate return pump 5300 (7 FIG. 9).

The preferred layout 5000 of FIG. 21 achieves up to an approximate 98 percent efficiency of the combined expander, steam condenser and steam generator, and these components can fit into a space of less than 3 by 1 by 1 foot space.

The simplicity and reduced parts in the system of FIG. 21 is can continuously run 24 hours a day seven days per week up to approximately 50,000 hours or more before any maintenance is needed, and does not require any lubrication for the system.

The invention can also use other heat recovery techniques and methods to maximize energy efficiency. For example, Thermal Photo Voltaic (TPV) devices can also be used with the invention to enhance energy efficiency. The TPV's generate electrical power from heat. TPVs can be installed on the exterior surface of an appropriate temperate surface and the electrical power generated (≈5W/cm²) will help satisfy parasitic electrical losses of devices such as the system pumps, blowers (fans), and the like, in the invention further increasing efficiency.

Although the invention has been described using a scroll expander drive as the prime mover, other devices such as reciprocating pistons, Wankle-type engines, turbines, and the like can also be utilized to make the invention work.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A steam generation system for producing electrical energy and for providing heat for domestic units, comprising:
a steam generator for generating steam from an energy source;
an expander drive for receiving the steam and for rotating a shaft and for generating co-generated heat;
an electrical generator connected to the rotating shaft for generating electrical power; and
a co-generator loop for receiving the co-generated heat and for supplying heated water for a domestic unit, and for being recycled back to the steam generator, where energy conversion efficiency achieves greater than a total of 95% of combined electrical energy conversion efficiency and co generation heat recovery efficiency.

2. The system of claim 1, wherein the energy conversion efficiency is greater than approximately 90%.

3. The system of claim 1, wherein the energy conversion efficiency is greater than approximately 95%.

4. The system of claim 1, wherein the expander drive further includes:
moveable parts which do not require lubrication to operate, and can run without maintenance for up to approximately 50,000 hours of operation.

5. The system of claim 1, wherein the expander drive further includes:
means for operating the expander drive at a high temperature and at a high pressure.

6. The system of claim 5, wherein the operating means includes:
first means for operating the expander drive up to approximately 1000F; and
second means for operating the expander drive up to approximately 600PSI.

7. The system of claim 1, wherein the electrical generator includes:
amorphous metallic permanent magnet components to increase efficiency up to approximately 97%.

8. The system of claim 1, wherein the steam generator includes:
a boiler.

9. The system of claim 8, wherein the boiler includes:
a mono-tube boiler which is explosion proof when punctured.

10. The system of claim 8, wherein the boiler includes:
stainless steel walls of approximately 0.083 inches thick.

11. The system of claim 8, wherein the boiler includes:
means for surrounding the boiler with helically wound fins to enhance heat transfer capability.

12. The system of claim 11, wherein the fins are formed from stainless steel.

13. The system of claim 1, further comprising:
a housing for the system having dimensions of approximately a space of less than approximately 3 by approximately 4 by approximately 5 feet.

14. The system of claim 13, wherein the housing includes:
an overall weight of up to approximately 500 pounds.

15. The system of claim 1, further comprising:
an air conditioning module operating from the electrical power.

16. The system of claim 1, wherein the domestic unit includes:
a hot water heater.

17. The system of claim 1, wherein the domestic unit includes at least one of:
an air heater and a radiator.

18. The system of claim 1, wherein the domestic unit includes:
at least one of a swimming pool, a spa, and a hot tub, etc.

19. The system of claim 1, further comprising:
means for selling excess electrical energy to a power grid.

20. The system of claim 1, wherein the energy source includes at least one of:
natural gas and propane or any fuel that can be atomized.

21. A method of supplying electrical and heat energy to a building, comprising the steps of:
locating a thermodynamic generating system at the building;
generating electrical energy from the thermodynamic generating system supplied from an energy source;
supplying all electrical and heat energy needs of the building with the generated electrical energy;
recycling co-generated heat from the thermodynamic generating system into a feed back loop; and
achieving a total energy conversion efficiency of greater than approximately 95% of combined electrical energy conversion efficiency and co generation heat recovery efficiency.

22. The method of claim 21, wherein the total energy conversion efficiency is up to approximately 95% efficiency.

23. The method of claim 21, further comprising the step of:
providing excess electrical energy from the thermodynamic generating system to an electrical power transmission grid; and
providing a monetary feedback to the building based on the excess electrical energy being provided.

24. A steam generation system for providing heat for domestic and commercial units, comprising:
a steam generator for generating steam from an energy source; and
a closed loop means for receiving heat from the steam generator and for supplying heated water for a domestic/commercial unit, and for being recycled back to the steam generator, where energy conversion efficiency achieves up to approximately 98% of combined energy conversion efficiency and heat recovery efficiency.

25. The steam generation system of claim 24, wherein the steam generator and the closed loop means are enclosed within a space volume of up approximately 1 foot by approximately 1 foot by approximately 2 foot.

26. The steam generation system of claim 24, wherein the domestic/commercial unit includes: a domestic hot water supply.

27. The steam generation system of claim 24, wherein the domestic/commercial unit includes: a space heater or radiant heater for heating air within a space.

28. The steam generation system of claim 24, wherein the domestic/commercial unit is selected from at least one of: a pool, a spa, and an underground piping system used for snow and ice removal.

29. A steam generation system for powering a vaporous fuel powered airconditioner, comprising:
a steam generator for generating steam from an energy source;
an expander drive which rotates a drive shaft;
a drive shaft driven air conditioner unit connected to the drive shaft of the expander drive, which generates cooled air output; and
a feedback loop means, where energy conversion efficiency achieves up to approximately 98% of combined energy conversion efficiency and heat recovery efficiency.

30. The steam generation system of claim 29, wherein the steam generator and the closed loop means are enclosed within a space volume of up approximately 1 foot by approximately 1 foot by approximately 3 foot.

31. A steam generation system for generating electrical power, comprising:
a steam generator for generating steam from an energy source;
an expander drive which rotates a drive shaft;
a drive shaft driven electrical generator unit attached to the drive shaft of the expander drive, which generates an electrical output; and
a feedback loop means, where energy conversion efficiency achieves up to approximately 98% of combined energy conversion efficiency and heat recovery efficiency.

32. The steam generation system of claim 31, wherein the steam generator and the closed loop means are enclosed within a space volume of up approximately 1 foot by approximately 1 foot by approximately 3 foot.

33. A steam generation system for powering a vaporous fuel powered vehicle, comprising:
a steam generator for generating steam from an energy source;
an expander drive which rotates a drive shaft;
an axle driven vehicle connected to the drive shaft of the expander drive; and
a feedback loop means, where energy conversion efficiency achieves up to approximately 98% of combined energy conversion efficiency and heat recovery efficiency.

34. The steam generation system of claim 33, wherein the steam generator and the closed loop means are enclosed within a space volume of up approximately 1 foot by approximately 1 foot by approximately 3 foot.

35. A steam generation system for generating electrical power to an electric driven vehicle, comprising:
a steam generator for generating steam from an energy source;
an expander drive which rotates a drive shaft;
a drive shaft driven electrical generator unit attached to the drive shaft of the expander drive, which generates an electrical output;
an electric driven vehicle being powered by the electric output; and
a feedback loop means, where energy conversion efficiency achieves up to approximately 98% of combined energy conversion efficiency and heat recovery efficiency.

36. The steam generation system of claim 35, wherein the steam generator and the closed loop means are enclosed within a space volume of up approximately 1 foot by approximately 1 foot by approximately 3 foot.
